(19) United States
(12) Patent Application Publication
(10) Pub. No.: US 2024/0230938 A1
(43) Pub. Date: Jul. 11, 2024

(54) DIGITAL SEISMIC FILE INGESTION

(71) Applicant: Schlumberger Technology Corporation, Sugar Land, TX (US)

(72) Inventors: Tharunya Danabal, Pune (IN); Rishabh Gupta, Pune (IN); Svapanil Patel, Pune (IN)

(21) Appl. No.: 18/537,958

(22) Filed: Dec. 13, 2023

(30) Foreign Application Priority Data
Dec. 15, 2022 (IN) 202221072542

(51) Int. Cl. G01V 1/30

(52) U.S. Cl. CPC G01V 1/301; G01V 2210/512; G01V 2210/514

(57) ABSTRACT

A method includes obtaining a digital seismic file, obtaining a digital seismic file, and performing autodetection of parameters of the digital seismic file. The method further includes extracting seismic data from the digital seismic file according to the parameters to generate normalized seismic data. The method further includes scanning the normalized seismic data to obtain metadata that includes geographic file boundaries and mapping the normalized seismic data to a parent virtual survey based at least in part on the geographic file boundaries being in a geographic region of a parent virtual survey. The method additionally includes storing, in a target store, the normalized seismic data and metadata, the normalized seismic data in a stored relationship with the parent virtual survey in the target store.

### CROSS REFERENCE TO RELATED APPLICATIONS

This application claims benefit under 35 U.S.C. § 119(a) to Indian Provisional Patent Application Serial Number 202221072542, filed on Dec. 15, 2023. Indian Provisional Patent Application Serial Number 202221072542 is incorporated by reference in its entirety. This application is related to PCT Patent Application No. PCT/US2022/025491 filed on Apr. 20, 2022. PCT Patent Application No. PCT/US2022/025491 is incorporated by reference in its entirety.

### BACKGROUND

In the oil and gas industry along with other industries, seismic surveys are performed to determine subterranean formations. For example, seismic surveys may be used to determine possible locations of hydrocarbons. Seismic surveys involve initiating a seismic wave at a first location and detecting refracted impulses at one or more seismic detectors. The amplitude and time of the refracted impulses are indicative of subterranean structures and resources. A digitally formatted seismic file (i.e., digital seismic file) is created as a result of a seismic survey. To use the seismic surveys, the digital seismic file is loaded into a software application. To load the seismic survey, parameters of the digital seismic files are extracted. The parameters not only include the data format and file parameters but also relate to the structure of seismic data within the digital seismic file.

Over time, large volumes of digital seismic files are created. Different acquisition tools and different software packages have different formats and structures. Thus, to load the large volumes, the individual parameters of the different digital seismic files need to be determined from the large volumes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to digital seismic file ingestion. Digital seismic file ingestion includes a method that includes obtaining a digital seismic file, obtaining a digital seismic file, and performing autodetection of parameters of the digital seismic file. Digital seismic file ingestion further includes extracting seismic data from the digital seismic file according to the parameters to generate normalized seismic data. Digital seismic file ingestion further includes scanning the normalized seismic data to obtain metadata that includes geographic file boundaries and mapping the normalized seismic data to a parent virtual survey based at least in part on the geographic file boundaries being in a geographic region of a parent virtual survey. Digital seismic file ingestion additionally includes storing, in a target store, the normalized seismic data and metadata, the normalized seismic data in a stored relationship with the parent virtual survey in the target store.

Other aspects of the disclosure will be apparent from the following description and the appended claims.

### BRIEF DESCRIPTION OF DRAWINGS

FIG. 1 shows a diagram of a system for acquiring digital seismic files.

FIG. 2 shows a diagram of a computing system for digital seismic file ingestion in accordance with disclosed embodiments.

FIG. 3 shows a flowchart for digital seismic file ingestion in accordance with disclosed embodiments.

FIG. 4 shows a flowchart for scanning the normalized seismic data and mapping the normalized seismic data to a parent virtual survey.

FIG. 5 shows a flowchart for using an Extended Binary Coded Decimal Interchange Code (EBCDIC) header to select a template in accordance with one or more embodiments.

FIG. 6.1 and FIG. 6.2 show an example detailed flowchart for selecting a template in accordance with disclosed embodiments.

FIG. 7 shows an example of metadata to extract in accordance with one or more embodiments.

FIG. 8 shows an example diagram to detect a parent virtual survey in accordance with one or more embodiments.

FIG. 9 shows an example of data records that may be stored in the data store using one or more embodiments.

FIG. 10.1 and FIG. 10.2 show computing systems in accordance with disclosed embodiments.

### DETAILED DESCRIPTION

Seismic survey operations are used to explore subterranean formations. The result of seismic survey operations is the generation of a digital seismic file. To be useful, software applications interpret seismic data in the digital seismic file. However, different types of seismic surveying tools and software acquisition packages exist. Each of the different types of seismic surveying tools and software acquisition packages may have different mechanisms for storing the seismic data. For example, the different mechanisms may relate to the ordering and sorting of seismic values, number of dimensions (e.g., whether two dimensional or three dimensional), stacking type, survey type, whether inline or crossline sorted, whether common reflective surface (CRS) is used, quality of seismic data, etc.

In order to simplify applications, a common data platform may be used to interpret and process the seismic data. The common data platform uses a normalized seismic data format. Because of the number of different mechanisms for storing seismic data, the various files are transformed into normalized seismic data before being ingested into the common data platform. Several petabytes of data may be ingested into the common data platform. One or more embodiments address the challenges of ingesting large volumes of seismic data. Specifically, one or more embodiments are directed to a computer system that performs the detection of parameters of digital seismic files, normalizes the seismic data in the digital seismic files, extracts metadata, identifies parent virtual surveys, and stores the normalized seismic data. Further, embodiments may check for duplicates as part of the ingestion process.

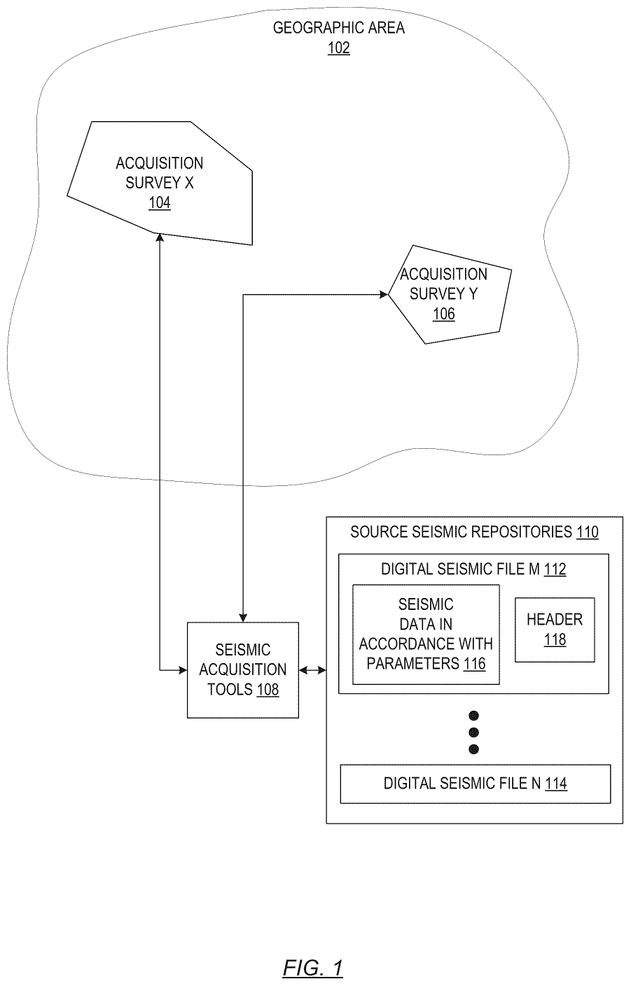

FIG. 1 shows a diagram of a system for acquiring digital seismic files. As shown in FIG. 1, one or more acquisition surveys (e.g., acquisition survey X (104), acquisition survey Y (106)) are defined. The same geographic area (102) may have multiple acquisition surveys. The definition of the acquisition survey includes the sub-region (i.e., sub-geographic area) in which the seismic data is gathered along with other acquisition parameters of how the seismic data is gathered. Such acquisition parameters may include the type of seismic acquisition tools (108) to use, settings of the equipment, timing information, etc.). During acquisition, seismic transmitters and receivers in the seismic acquisition tools (108) obtain seismic data. Seismic data is stored in the source seismic repositories (110).

The source seismic repositories (110) are any type of storage unit and/or device (e.g., a file system, database, collection of tables, or any other storage mechanism) for storing data. Further, the source seismic repositories (110) may include multiple different storage units and/or devices that may be co-located or in distributed locations. The multiple different source seismic units or devices may be in heterogeneous locations and have heterogeneous operators. For example, the source seismic repositories (110) may be a set of sources of seismic data from different companies that each gather seismic data. The source seismic repository (110) is configured to store digital seismic files (e.g., digital seismic file M (112), digital seismic file N (114)).

A digital seismic file (e.g., digital seismic file M (112), digital seismic file N (114)) includes seismic data stored in accordance with parameters (116) and a header (118). Although the contents of a single digital seismic file are shown in FIG. 1, the other digital seismic files may also have the same type of contents. The seismic data is data acquired through an acquisition survey (e.g., acquisition survey X (104), acquisition survey Y (106)) that is directly or indirectly stored by the seismic acquisition tools (108) in the digital seismic file as known in the art. A single acquisition survey may have multiple digital seismic files generated from the single acquisition survey.

The seismic data may be a set of seismic traces in the digital seismic files. The term “seismic trace” complies with the standard definition used in the art. For example, a seismic trace may be characterized as a recording of the Earth's response to seismic energy passing from the source, through subsurface layers, and back to the receiver. Hundreds or thousands of seismic traces may be in the same digital seismic file. A seismic trace has seismic values, which is the seismic data in the seismic trace. For example, the seismic value may be the Earth's frequency response for a particular time.

Seismic data is stored in accordance with parameters (116). The parameters may be explicitly stored in the digital seismic file, implicitly stored, or be extrapolated from the particular seismic values in the digital seismic file. The parameters not only include the data format and file parameters but also relate to the structure of seismic data within the digital seismic file. One or more of the parameters may not be stored in the digital seismic file as parameter name, parameter value pairs. Rather, parameters may be interpreted from a matching template or extrapolated based on attributes of the seismic value.

The parameters of the seismic data store information about the content of the seismic data and acquisition technique rather than datatype, file format, and file metadata. By way of an example, the parameters include stacking parameters (e.g., pre-stack, post-stack), dimensions of seismic survey (e.g., two-dimensional, three-dimensional data captured), sorting code, the sort key (e.g., inline or crossline sort key), survey type, byte locations of the shot point location (SP) value/common depth point (CDP) value, and X and Y coordinates of the source (e.g., Sx and Sy byte offsets). The header (118) provides some parameters of the digital seismic file (e.g., digital seismic file M (112)). Because of the heterogeneity of seismic acquisition tools (108), the location and the format of the headers in the various digital seismic files are also heterogeneous.

The acquisition of seismic data shown in FIG. 1 may be performed at various stages of planning a well or performing other subsurface operations. For example, during early exploration stages, seismic data may be gathered from the surface to identify possible locations of hydrocarbons, water, or other underground resources. The seismic data may be gathered using a seismic source that generates a controlled amount of seismic energy. In other terms, the seismic source, and corresponding sensors are an example of a data acquisition tool. An example of a seismic data acquisition tool is a seismic acquisition vessel that generates and sends seismic waves below the surface of the earth. Sensors and other equipment located at the field may include functionality to detect the resulting raw seismic signal and transmit raw seismic data to a surface unit. The resulting raw seismic data may include the effects of one or more seismic waves reflecting from the subterranean formations.

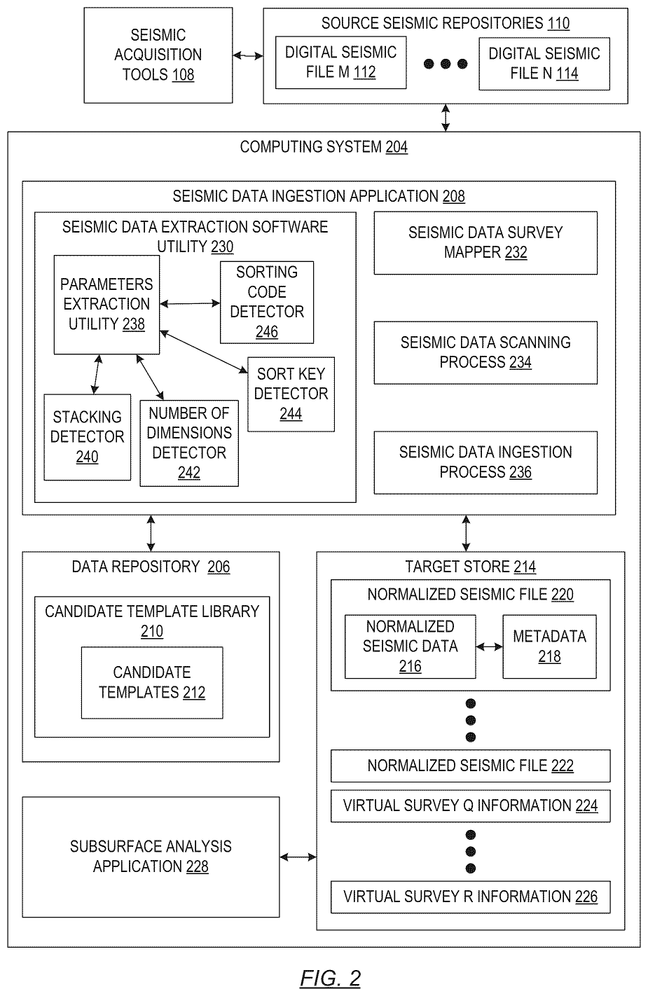

One or more embodiments are directed to a unified system for ingesting digital seismic files from possibly disparate sources. FIG. 2 shows a diagram of a computing system for digital seismic file ingestion in accordance with disclosed embodiments.

The seismic acquisition tools (108) and the source seismic repositories (110) are the same as discussed above with reference to FIG. 1. The source seismic repositories (110) are directly or indirectly connected to a computing system (204) as shown in FIG. 2.

The computing system (204) includes a data repository (206) and seismic data ingestion software application (208). The data repository (206) is any type of storage unit and/or device (e.g., a file system, database, collection of tables, or any other storage mechanism) for storing data. Further, the data repository (206) may include multiple different storage units and/or devices. The multiple different storage units and/or devices may or may not be of the same type or located at the same physical site.

The data repository (206) includes functionality to store a candidate template library (210) that includes candidate templates (212). The candidate template library (210) stores a collection of candidate templates (212). Candidate templates may not be defined for particular digital seismic files or data acquisition tools. By way of an example, candidate templates may be defined based on user experience. Rather, candidate templates are possible templates that, on their face, are equally applicable to the digital seismic files. Thus, determining which candidate template to apply is performed in one or more embodiments herein by testing the various candidate templates on the digital seismic file. One or more of the candidate templates may include various combinations of byte locations for at least some of the parameters. Specifically, the candidate template may identify a location in the digital seismic file where a particular parameter may be stored.

The data repository (206) is communicatively connected to a seismic data ingestion application (208). The seismic data ingestion application (208) is software (e.g., a standalone application or part of another application) that is configured to ingest digital seismic files into a target store (214).

The target store (214) is a common data platform that stores normalized seismic data (216). Specifically, the target store (214) is any type of data repository that stores seismic data in a normalized format (216). The normalized format may be a transformation of individual seismic traces in the seismic data files to comply with the specification of the target store. As another example, the normalized format may be adding metadata or headers to the seismic data so that the seismic data is directly interpretable. In one or more embodiments, the target store is an OSDU® Data Platform (OSDU is a registered trademark of The Open Group).

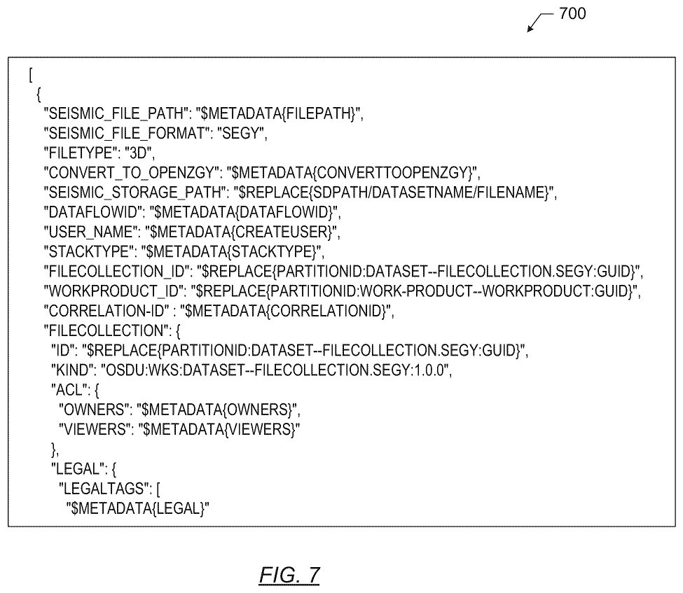

In one or more embodiments, the normalized seismic data (216) is stored with metadata (218) in normalized seismic files (e.g., normalized seismic file (220), normalized seismic file (222)). In one or more embodiments, a normalized seismic file is a transformation of a corresponding digital seismic file. Specifically, when a digital seismic file is ingested, the digital seismic file is transformed into the corresponding normalized seismic file. In addition to seismic data, the normalized seismic file includes or is otherwise connected to metadata (218). The metadata (218) is information describing the seismic data. The metadata may include at least one of the corner points of seismic data, an inline boundary, a crossline boundary, and a sampling rate. The corner points of the seismic data are values demarcating the boundaries of the seismic traces in the normalized seismic data. The sampling rate is the frequency of the sample points for the seismic traces. Examples of metadata is presented in FIG. 7 below.

In one or more embodiments, the target store (214) may also store virtual survey information (e.g., virtual survey Q information (224), virtual survey R information (226)). Virtual survey information is information describing a virtual survey. A virtual survey may be the same as an acquisition survey of FIG. 1 or representative of an acquisition survey. For example, using the parameters of an acquisition survey, a human may specify a virtual survey based on and/or to match the corresponding acquisition survey. As another example, the specification of the acquisition survey may be used to automatically generate a virtual survey. In one or more embodiments, the goal of defining a virtual survey is to have the same boundaries as the acquisition survey. However, the boundaries may not align, due to error or other reasons. The definition of a virtual survey is stored as virtual survey information (e.g., virtual survey Q information (224), virtual survey R information (226)). Namely, the virtual survey is stored in the target store as virtual survey information. The virtual survey information may include the boundaries of the virtual survey, a bin spacing of the virtual survey, and a grid orientation of the virtual survey. A bin is a subdivision of a seismic survey. The area of a three-dimensional survey is divided into bins, such as on the order of 25 m [82 ft] long and 25 m wide. Traces are assigned to specific bins according to the midpoint between the source and the receiver, reflection point, or conversion point. The grid orientation is the alignment of the grids of the time-lapse data to a common grid orientation.

Continuing with FIG. 2, the target store (214) is connected to a subsurface analysis application (228). The subsurface analysis application (228) is any application that uses the seismic data to determine information about the subsurface. For example, the subsurface analysis application (228) may be an oilfield application for performing exploration and production operations, a geothermal application, or other application that uses seismic data.

The target store (214) is also connected to a seismic data ingestion application (208). The seismic data ingestion application (208) is a software application that is configured to ingest seismic data files and populate the target store (214). The seismic data ingestion application (208) includes a seismic data extraction software utility (230), a seismic data survey mapper (232), a seismic data scanning process (234), and a seismic data ingestion process (236). Each of these components is described below.

The seismic data extraction software utility (230) is a software code (e.g., in a single program, a collection of programs, or a software library) that is configured to automatically extract seismic data from the digital seismic file. The seismic data extraction software utility (230) includes a parameters extraction utility (238) and various components for extracting individual parameters. The parameters extraction utility (238) is configured to manage the extraction of individual parameters of digital seismic files. The parameter extraction utility (238) may be configured to process batches of digital seismic files and register parameters for each of the batches of digital seismic files. For example, a user may provide, to the parameter extraction utility, an identifier of a storage location of a collection of digital seismic files. The parameter extraction utility (238) may access the collection, individually extract parameters, and register the parameters with the corresponding digital seismic file.

The parameter extraction utility (238) may be connected to the various components that perform the extraction of particular parameter types. For example, a stacking detector (240) may be configured to determine the stacking type of the digital seismic file. The number of dimensions detector (242) may be configured to determine the number of dimensions of the seismic data in the digital seismic file. The sort key detector (244) may be configured to determine the sorting type of the digital seismic file. The sorting code detector (246) may be configured to determine the sorting code of the digital seismic file.

The seismic data ingestion application (208) also includes a seismic data survey mapper (232). The seismic data survey mapper (232) is configured to map a digital seismic file to a parent virtual survey. The parent virtual survey is the virtual survey that matches the digital seismic file. In one or more embodiments, the matching of the parent virtual survey is with respect to a containment of the geographic region of a digital seismic file within the boundaries of the virtual survey and having matching grids.

The seismic data scanning process (234) is configured to scan the seismic data and extract metadata from the scanning. The seismic data ingestion process (236) is configured to transform the digital seismic file into a normalized seismic file, store metadata into the normalized seismic file, check for duplicated data, and store the normalized seismic file in the target store (214).

While FIG. 1 and FIG. 2 show configurations of components, other configurations may be used without departing from the scope of the disclosure. For example, various components may be combined to create a single component. As another example, the functionality performed by a single component may be performed by two or more components.

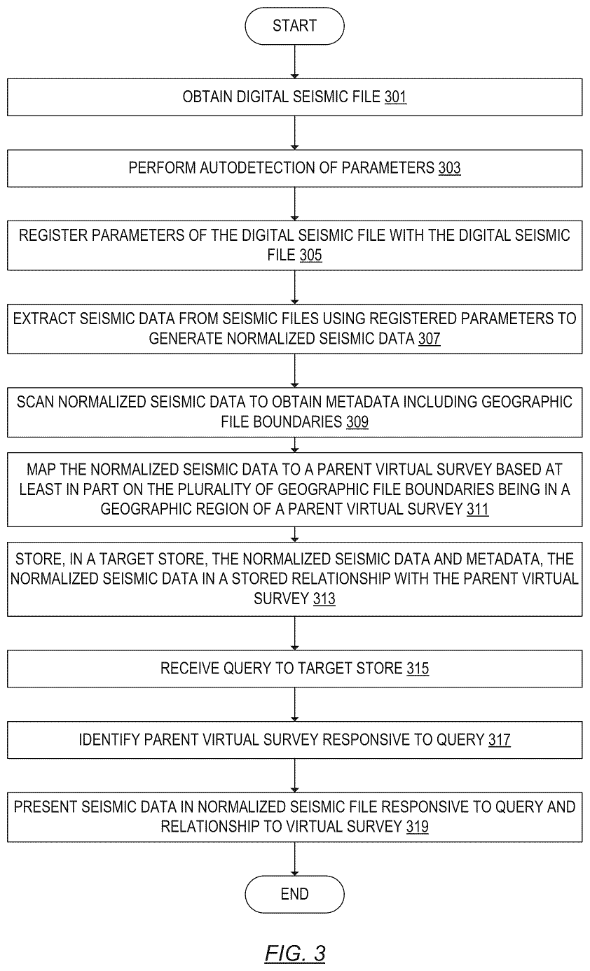

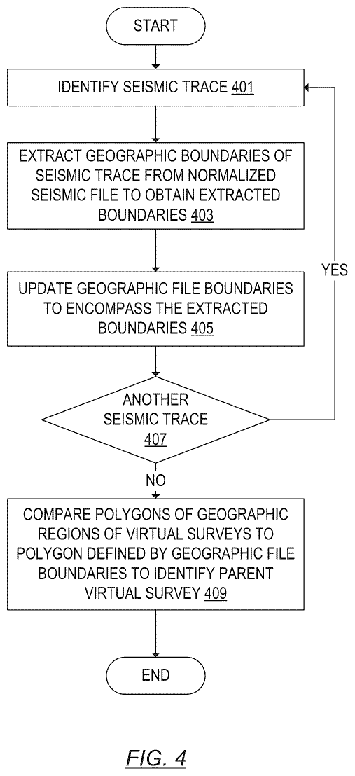

FIG. 3 and FIG. 4 show flowcharts in accordance with one or more embodiments of the disclosure. FIG. 3 shows a flowchart for ingesting and using a digital seismic file. FIG. 4 shows a flowchart for detecting a parent virtual survey. One or more of the blocks in FIG. 3 and FIG. 4 may be performed by the components of the system discussed above in reference to FIG. 2. In one or more embodiments, one or more of the blocks shown in FIG. 3 and FIG. 4 may be omitted, repeated, and/or performed in parallel, or in a different order than the order shown in FIG. 3 and FIG. 4. Accordingly, the scope of the disclosure should not be considered limited to the specific arrangement of blocks shown in FIG. 3 and FIG. 4.

At Block 301, a digital seismic file is obtained in one or more embodiments. Seismic surveying is performed in a field, and a digital seismic file is created and stored. Over time, many digital seismic files are saved in storage. The various digital seismic files may be disassociated with the tools used to create the digital seismic files. As such, opening the digital seismic file may be simply to see numbers without the meaning of that which the numbers represent. In one or more embodiments, the parameter extraction utility is provided with a location of one or more digital seismic file. The parameter extraction utility accesses the location and opens the digital seismic file.

At Block 303, autodetection of parameters is performed. The autodetection of the parameters may be performed as follows.

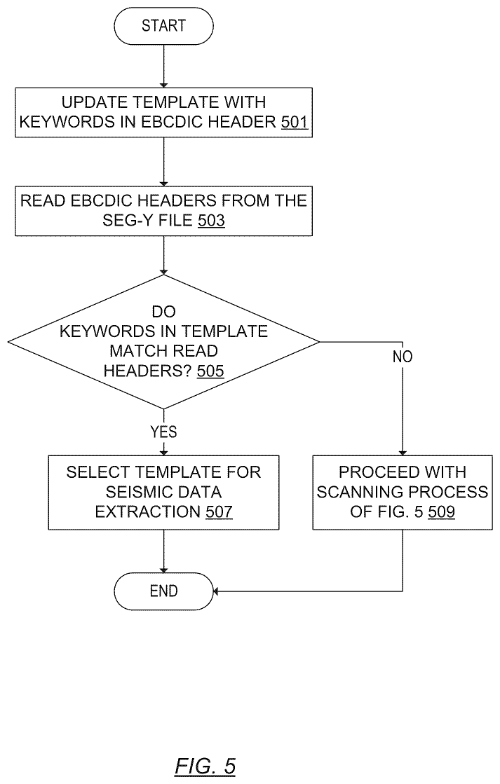

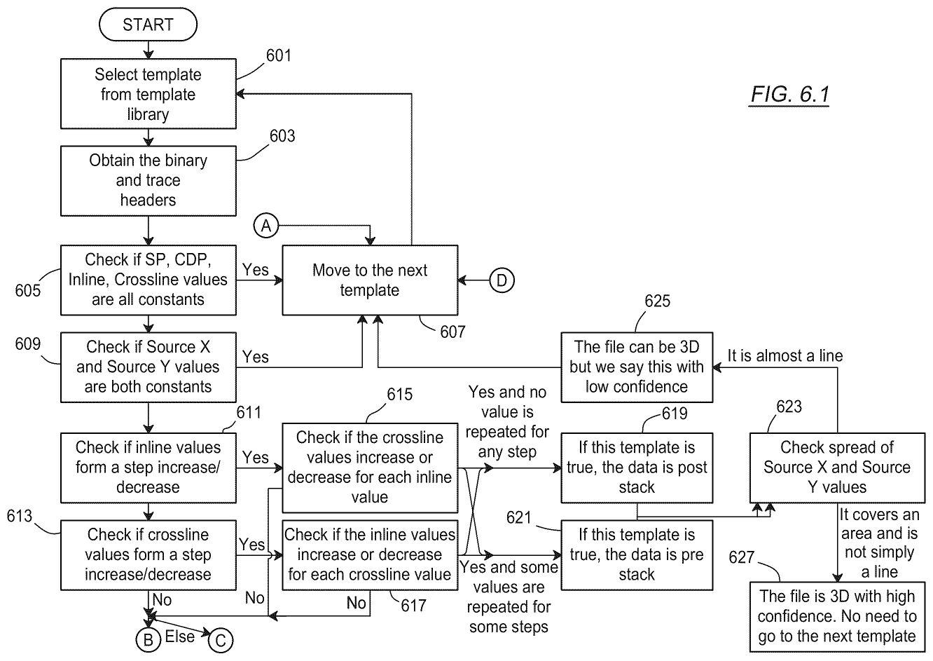

Extraction of an EBCDIC header may be attempted. If an EBCDIC header is found, the EBCDIC header may have a template corresponding to the EBCDIC header. Using the EBCDIC header to select a template is described in reference to FIG. 5. After detecting a template, the parameters may be extracted based on the template. If a template is not found, then the process may continue as described below.

A target candidate template may be obtained. The parameter extraction utility selects a candidate template from the candidate template library. The order of selection may be based, for example, on probabilistic selection based on a candidate template that previously successfully extracted parameters. The candidate template that is currently being used to attempt to extract parameters is referred to as the target candidate template. Namely, the target candidate template is the candidate template that is actively being used to attempt parameter extraction. With parallel processing, multiple such targets may be used concurrently and in parallel to attempt extraction.

Extraction of the binary header may be attempted using the target candidate template. In one or more embodiments, the digital seismic file is a binary file. The binary header may be at a defined location in the digital seismic file. For example, the binary header may be a set of bytes starting at location X, where X is well defined. If not enough information is in the binary header, then the target candidate template is determined to be unable to extract the binary header. As another example, if all zeros are found, then the target candidate template may be determined to be unable to extract the binary header.

Extraction of the trace header is attempted using the target candidate template. The trace header may be determined to be after the binary header. An attempt is made to extract the trace header according to the values in the target candidate template. For example, the target candidate template may specify the possible location of the trace header. The trace header may be around two hundred and forty bytes. Out of the two hundred and forty bytes, the SP or the CDPs or domain crossline values may be located in any of the two hundred and forty bytes. The target candidate template may be used to identify, in the two hundred and forty bytes, where each of the parameters may be found. If all zeros or less than a threshold amount of data is found in the trace header, then the target candidate template is determined to be unable to extract the trace header.

A determination is made whether the target candidate template successfully extracted headers. If the target candidate template did not successfully extract the binary header or the trace header, then the process may repeat to try another target candidate template. If the target candidate template does extract the headers, then the process continues as discussed below.

Parameters may be attempted to be extracted using the candidate template. The target candidate template may specify the byte locations of some of the parameters. In such a scenario, for each byte location identified, the value in the digital seismic file at the byte location is extracted. A determination is made whether the value matches a possible value for the parameter. If the value matches, then the parameter is assumed to be the value at the byte location. If the value at the byte location is not a possible value, then the probability of the target candidate template being a match is lowered.

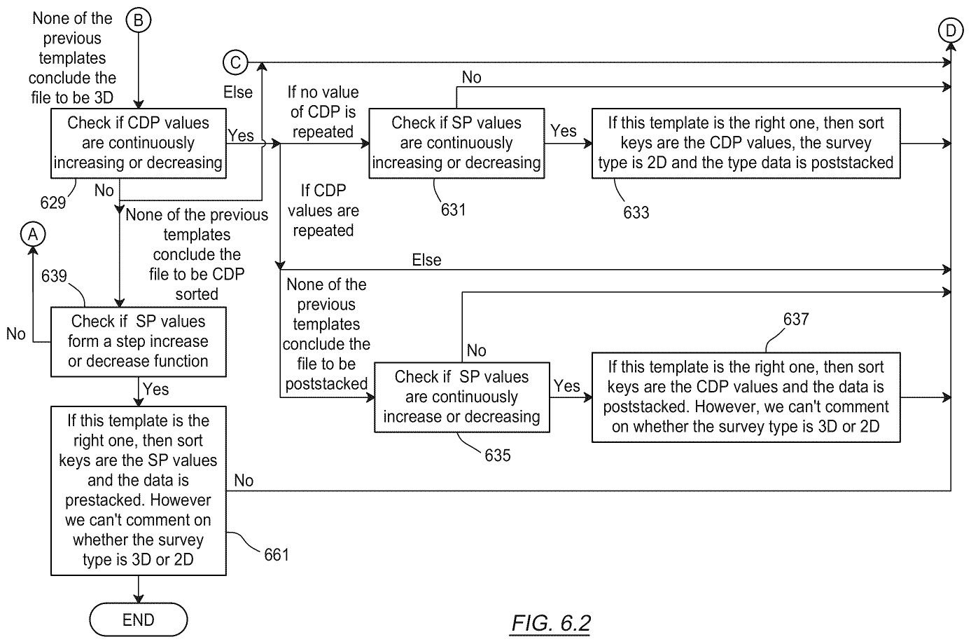

Some parameters may be determined through statistical interpretation. For example, using inline and crossline trends, a determination is made whether the digital seismic file is three-dimensional or two-dimensional. If the digital seismic file is not three dimensional, then a determination may be made whether the digital seismic file is CDP sorted. If the digital seismic file is not CDP sorted, a test may be performed to check an SP step trend of the digital seismic file. If the digital seismic file has an SP step trend, then the parameters include the file being two dimensional and SP sorted. FIG. 6.1 and FIG. 6.2 show a detailed flowchart for extracting parameters in accordance with one or more embodiments.

Continuing with the discussion of Block 303, a determination is made whether the target candidate template successfully extracts the parameters. Successful extraction may be based on satisfying a threshold probability of being accurate. In particular, because at least some of the parameters are inferred, at least some of the parameters may have less than a hundred percent probability of being correct. Accordingly, the extraction of a parameter may be associated with the probability. The cumulative probability of at least a subset of the parameters may be compared against the threshold probability. If the cumulative probability satisfies the threshold probability, then the target candidate template may be deemed to successfully extract parameters. Otherwise, the target candidate template may be deemed unsuccessful. If the target candidate template successfully extracts parameters, the flow may end. In some embodiments, the cumulative probabilities are compared across multiple target candidate templates. The target candidate template having the greatest cumulative probability may be selected.

If a target candidate template does not successfully extract the parameters, the flow may continue to the next target candidate template. The process may repeat for the various candidate templates in the candidate template library until a matching candidate template is found that successfully extracts the parameters.

Continuing with FIG. 3, at Block 305, the parameters of the digital seismic file are registered with the digital seismic file. Registering the parameters includes storing identifiers of the parameters with the file and/or an identifier of the file. Namely, registering the parameters creates a stored association between the values of the parameters and the digital seismic file. For example, the parameter identifiers may be added to the metadata of the file. The parameter identifiers may be stored as parameter name, parameter value pairs. As another example, the parameter identifiers may be stored as a data structure of values, whereby the position of the values in the data structure identifies the parameter name of the parameter. Different techniques may be used to register the parameters of the digital seismic file with the digital seismic file. The various techniques may be used.

At Block 307, seismic data is extracted from the seismic files using the registered parameters to generate a normalized seismic file. Using the parameters, individual seismic values are interpreted. Namely, based on the location of the individual seismic value in the seismic survey and the parameter, the scanning process can identify that which the value represents. The seismic data is extracted based using the template and stored in a normalized seismic file. In one or more embodiments, the seismic data is stored in a JavaScript Object Notation (JSON) file. Other file types and storage structures may be used without departing from the scope of the claims.

At Block 309, the normalized seismic data is scanned to obtain metadata that includes geographic file boundaries. The system scans these large volumes of seismic data to extract metadata such as trace outlines, grid boundaries, corner point boundaries, sampling rate, inline crossline values for three-dimensional seismic data, etc. To evaluate the dataset visually, metadata such as all trace outlines, live trace outlines, and grid boundaries are extracted by the system from the normalized seismic data. The various normalized seismic data are converted into coordinates that may be spatially visualized.

At Block 311, the normalized seismic data is mapped to a parent virtual survey based at least in part on the plurality of geographic file boundaries being in a geographic region of a parent virtual survey. The computing system of FIG. 2 then automatically maps the normalized seismic data to the appropriate parent virtual survey based on spatial context. The mapping may be performed using machine learning algorithms, thereby easing the entity relationship management in the target store.

In one or more embodiments, the process of determining the geographic file boundaries and identifying the parent virtual survey is described in FIG. 4. Turning briefly to FIG. 4, in Block 401, a seismic trace is identified. Using the template, the system iterates through the seismic traces in the normalized seismic data. For each of at least a subset of seismic traces, the system extracts one or more geographic boundaries of the seismic trace to obtain one or more extracted boundaries in Block 403. For example, the extracted boundaries may be the locations of the seismic trace. The system then updates the geographic file boundaries to encompass the extracted boundary. Initially, for the first analyzed seismic trace, the updating of the geographic file boundary creates a new set of geographic file boundaries that is the same as the extracted boundaries. After the geographic file boundaries are defined, the updating may be performed by determining whether the geographic file boundary already includes the extracted boundaries. If the geographic file boundary already includes the extracted boundary, then the flow proceeds. However, if the geographic file boundary does not include the extracted boundary (e.g., the extracted boundary is outside of the region of the geographic file boundary), then the geographic file boundary is moved to expand the region of the seismic traces to encompass the extracted boundary. For example, at least one of the geographic file boundaries may be moved.

In Block 405, a determination is made whether another seismic trace is in the normalized seismic file. If another seismic trace is in the normalized seismic data, the flow returns to Block 401. If another seismic trace is not in the normalized seismic data, then the flow may proceed to Block 409.

In Block 409, the polygons of the geographic region of the virtual surveys are compared to the polygon defined by the geographic file boundaries to identify a parent virtual survey. One or more embodiments automatically define the relationship between seismic entities, such as the normalized seismic data and parent virtual surveys that belong to an survey type. The best matching parent virtual survey is identified by the computing system using the geographic file boundaries of the normalized seismic data extracted above and compared with already existing parent virtual surveys. To perform the identification of the best match, a polygon in polygon algorithm may be used. The polygon in polygon algorithm is a technique by which the polygons (e.g., geographic file boundary polygon and virtual survey polygon) are plotted. A check is performed whether the geographic file boundary polygon is within the virtual survey polygon. Further, the surveys that are used in comparison have boundaries defined in the same coordinate reference system as the geographic file boundary. If the surveys are different, then one or more embodiments converts the points into a common Coordinate reference system and then does the polygon in polygon comparison.

In one or more embodiments, polygons of virtual surveys are compared to a polygon defined by the geographic file boundary to obtain a comparison result. The parent virtual survey is selected from the virtual surveys based on the comparison result. In one or more embodiments, a bounding box is created around the geographic file boundary. The bounding boxes of the parent virtual surveys are compared to the bounding box of the geographic file boundary. The parent virtual survey that has a bounding box encompassing the geographic file boundary of the normalized seismic data is selected.

In one or more embodiments, the grid orientation and grid resolution of the virtual survey are also compared to the normalized seismic data. Specifically, if the virtual survey does not have the same orientation or resolution, the virtual survey may be excluded from the matching process.

Returning to FIG. 3, at Block 313, the normalized seismic data is stored in the target store to have a stored relationship with the parent virtual survey. In one or more embodiments, prior to storage, a check is performed to determine whether the normalized seismic data is already stored. Specifically, the normalized seismic data is validated to confirm that the normalized seismic data is not a duplicate of seismic data stored in the target store. The validation may be performed by comparing a checksum of a normalized seismic file having the normalized seismic data with checksums in the target store to determine whether the normalized seismic data is already stored in the target store. If the checksum of the normalized seismic file matches an existing checksum, then the data may be determined to be a duplicate. In such a scenario, further matching processes may be performed, and the data may be ignored so as to not be ingested. The result is preventing the overuse of computing system resources by preventing unintentional duplicate data storage.

The computing system handles the data transfer efficiently. For example, 1.5 Terabytes of digital seismic data may be processed at any given moment. For seismic data, the normalized seismic data file may be stored in the Seismic domain management service. The data is transformed to be represented and stored in accordance with the target store schema (e.g., the OSDU schema). Individual data records may be created for trace data, seismic bin grid, and the normalized seismic data file that is copied. The metadata generated above, such as corner point boundaries, sampling rate, and inline crossline values for 3D seismic, is mapped to the metadata section in the target store records created. The storage may be performed using templates that are stored and managed in the computing system. Because the seismic data is stored in a normalized format, the seismic data may be used.

At Block 315, a query to the target store is received. A subsurface analysis application may have a geographic region to perform the analysis. Further, the subsurface analysis application may have a type of seismic data. Thus, the subsurface analysis application creates a query with the location and type. The query is sent to the target store.

At Block 317, the parent virtual survey is identified responsive to the query. Based on the location, the parent virtual survey is determined. For example, the parent virtual survey that covers the geographic region in the query may be identified.

At Block 319, the seismic data in the normalized seismic file is presented responsive to query and a stored relationship to virtual survey. From the parent virtual survey, a set of normalized seismic files that have a stored relationship with the parent virtual survey is determined. The metadata of the normalized seismic files is compared to the query to identify the normalized seismic file satisfying the query. One or more seismic traces may be extracted from the normalized seismic file and returned to the subsurface analysis application. Thus, the subsurface analysis application uses the normalized seismic data to analyze the underground formations.

FIG. 5 shows a flowchart for using EBCDIC headers to detect a template to extract seismic data. In Block 501, the templates are updated with keywords in the EBCDIC header. EBCDIC headers is in a section in a SEG-Y file and contains information such as DATA TRACES, SAMPLE INTERVAL, PATTERN, etc. Human intervention may be used to read the EBCDIC headers and label the some keywords in a set of SEG-Y files. The labeled keywords are saved as an additional component in the existing Seismic trace template. By saving the keywords, the link between information in the EBCDIC headers to Trace Headers is established.

In Block 503, the EBCDIC headers are read from the SEG-Y file to obtain an extracted header. In one or more embodiments, the SEG-Y file is a type of digital seismic file. The EBCDIC header is read from the file and is an extracted header. A determination is made in Block 505 as to whether the keywords in a template match the read headers to obtain a determination result. If the determination result indicates that a template exists with matching keywords, then the template is selected for seismic data extraction. The flow may proceed with Block 303 of FIG. 3. If the determination result indicates that a template does not exist, the flow may proceed to FIG. 6.1 and FIG. 6.2 to select a matching template to extract the seismic data.

FIG. 6.1 and FIG. 6.2 show a detailed diagram to extract parameters from the digital seismic file. As shown in FIG. 6.1 and FIG. 6.2, a target candidate template is selected from the candidate template library (602). The binary and trace headers are obtained (603). In each of the operations described below, the target candidate template is used to extract information from the binary file. Namely, the target candidate template is used in the operations below as if the target candidate template is accurate. For example, particular seismic values may be extracted for the operations below according to the target candidate template. A determination is made whether the SP, CDP, inline, and crossline values are constants (605) in the headers. If the SP, CDP, inline, and crossline values are detected as being constant values, then the current target candidate template is determined to be unsuccessful. The flow proceeds to move to the next target candidate template (607).

If the SP, CDP, inline, and crossline values are not all detected as being constants, then the system detects whether the source X and source Y values are both constants (609). If the source X and the source Y values are both constant values, then the current target candidate template is determined to be unsuccessful. The flow proceeds to move to the next target candidate template (607).

If the source X and the source Y values are not both constant values, the flow proceeds to check for step increase or decrease in block (611) and block (613). At block (611), a determination is performed whether the inline values form a step increase or a step decrease. If the inline values are detected as forming a step increase or a step decrease, then a determination is made whether the crossline values increase or decrease for each inline value (615). If the inline values are detected as forming a step increase or a step decrease (i.e., but not both), and the crossline values increase or decrease (i.e., but not both) for each inline value, then the flow proceeds to block (619) or block (621) based on whether some values are repeated. Namely, if no value is repeated, then the target candidate template is determined to be accurate, and the seismic data is post-stacked (619). Specifically, a stacking parameter of the digital seismic file is post-stacked. Returning to block (615), if some crossline values repeat for each inline value, then the target candidate template is determined to be accurate, and the seismic data is pre-stacked (621).

Returning to blocks (611) and (613), if the inline values do not form a step increase or decrease, then a determination is made whether the crossline values form a step increase or decrease (613). If the crossline values are detected as forming a step increase or a step decrease, then a determination is made whether the inline values increase or decrease for each crossline value (617). If the crossline values are detected as forming a step increase or a step decrease (i.e., but not both), and the inline values increase or decrease (i.e., but not both) for each crossline value, then the flow proceeds to block (619) or block (621) based on whether some values are repeated. Namely, if no value is repeated, then the target candidate template is determined to be accurate, and the seismic data is post-stacked (619). Specifically, a stacking parameter of the digital seismic file is post-stacked. Returning to block (617), if some crossline values repeat for each inline value, then the target candidate template is determined to be accurate, and the seismic data is pre-stacked (621).

At block (623), the spread of the source X value and source Y value. If the spread of the source X value and source Y value is detected as being linear within a tolerance (e.g., at least almost a line), then the file is determined to be three-dimensional. However, the parameter of the file being three-dimensional has a lower probability of being accurate. The flow may proceed to block (607), and the next target candidate template is selected. The target candidate template and the parameters in the previous operations may be saved. The level of extraction between target candidate templates may be compared.

Returning to block (623), if the spread of source X and source Y values satisfy a threshold area, then the seismic data in the digital seismic file is detected as being three-dimensional (627). The digital seismic file is detected as having a parameter of three-dimensional with a high confidence. Further, the determination may be made that the target candidate value is accurate. As such, the operations may stop.

Returning to block (613), if not of the previous templates conclude the digital seismic file to be three dimensional, then a determination is made whether the CDP values are continually increasing or decreasing (629). If the CDP values are continually increasing or decreasing (629), then a determination is made whether the CDP values are repeated. If no value of the CDP is detected as repeated, then a determination is made whether the SP values are continuously increasing or decreasing (631). If no value of the CDP is detected as repeated and the SP values are not detected as continuously increasing or decreasing, then the target candidate template is determined to be unsuccessful, and the flow proceeds to block (607) to obtain the next target candidate template. If no value of the CDP is detected as repeated and the SP values are detected as continuously increasing or decreasing, then the target candidate template is determined to be correct. The parameter of the sort key is the CDP values, the survey type is tow-dimensional, and the seismic data is detected as being post-stacked at (633). The flow may proceed to block 407 to check another target candidate template.

Returning to block (629), if the CDP values are continuously increasing or decreasing and some of the CDP values are repeated, then a determination is made whether any of the previous templates identify the digital seismic file to be post-stacked. If the previous templates have not identified the file to be post-stacked, then a determination is made whether the SP values are detected to be continuously increasing or decreasing (635). If the SP values are not detected as continuously increasing or decreasing, then the target candidate template is determined to be unsuccessful.

If the SP values are detected as continuously increasing or decreasing, then a determination is made that the target candidate template is accurate, the source keys are detected as being the CDP values, and the data is detected as being post-stacked (637). The dimensions of the survey may be unknown when the flow proceeds to block (637). Other target candidate templates may be processed in one or more embodiments. If the conditions of block (631) and block (635) are not satisfied, the flow may return to block (607) to process the next target candidate template.

Returning to block (629), if the CDP values are not continually increasing or decreasing and none of the previous candidate templates determine that the digital seismic file is post-stacked, the flow proceeds to block (639) to determine whether the SP values form a step increase or decrease function. If the SP values are detected as not forming a step increase or decrease function in block (639), then the target candidate template is identified as correct. The sort keys are detected as the SP values and the seismic data is pre-stacked at block (641). The dimensions of the seismic data may be unknown.

The operations of FIG. 6.1 and FIG. 6.2 may be repeated for at least a subset of the target candidate templates. The parameters and respective probabilities may be compared to identify the target candidate template that has the greatest probability of being accurate. The extracted parameters of the target candidate template that has the greatest probability of being accurate are selected. After selecting the selected template, the selected template may be used in Block 303 as described above to extract parameters and the seismic data.

FIG. 7 shows an example template (700) of metadata that may be extracted and stored with the normalized seismic data. In the template in FIG. 7, placeholders are denoted by the “$” sign. The placeholders are replaced with output extracted in scanning in Block 309 of FIG. 3. Using the template, the system may ensure that the entity relationship between the related entities is intact. The extracted metadata may be used for data management workflows and consumption in subsurface analysis applications, such as end-user geoscience applications. As shown in FIG. 7, the data extracted may include the file path and format of the normalized seismic file, the file type, a storage path of seismic data, a username, a file collection identifier, and other information. Additional metadata may be included that is not shown in one or more embodiments.

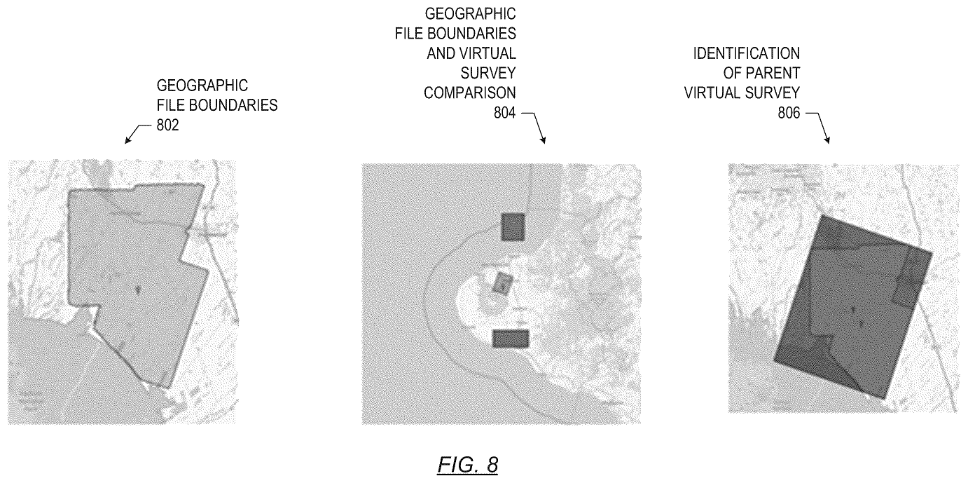

FIG. 8 shows an example of identifying a parent virtual survey using geographic file boundaries in accordance with one or more embodiments.

Specifically, as shown in the left image of FIG. 8, the geographic file boundaries (802) may be an uneven polygon with various boundaries around the seismic traces within the digital seismic file, and correspondingly, the normalized seismic file.

As shown in the center image of FIG. 8, a comparison is performed between the geographic file boundaries and the virtual surveys (804). In the center image, there are three virtual surveys each having different regions. Two of the virtual surveys (i.e., the top and bottom virtual surveys denoted by the rectangles) do not overlap with the geographic file boundaries of the normalized seismic data. However, as shown in the right image, zooming in on the geographic file boundaries in the middle of the center image shows the matching parent virtual survey (806). As shown in the image on the right of FIG. 8, the identification of the parent virtual survey (806) may be based at least in part on the polygon of the parent virtual survey encompassing the polygon of the geographic file boundaries. The resulting relationship may be stored as part of ingesting the seismic data.

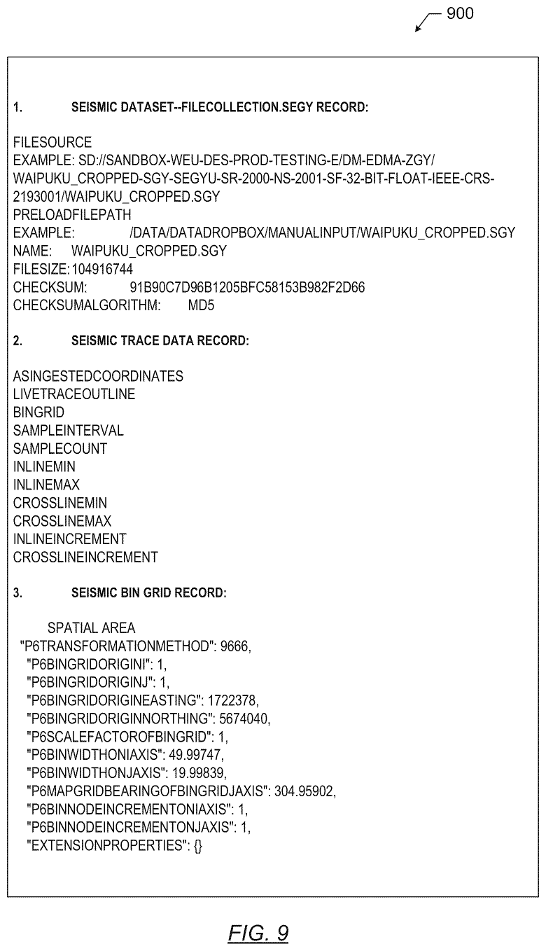

FIG. 9 shows an example of data records that may be created by the scanning process of FIG. 3 and stored in the target store as part of ingesting the digital seismic data. Specifically, FIG. 9 shows an example of ingesting the Gulfaks.segy file. As shown in FIG. 9, a seismic dataset-filecollection.segy record is created and stored in the target store. The seismic dataset-filecollection.segy may be the normalized seismic file and the record is the stored record created using the template shown in FIG. 7. Additionally, a seismic trace data record may be created and stored, and the seismic bin grid record may be created and stored using the system and process described in FIG. 2, FIG. 3, FIG. 4, FIG. 5, FIG. 6.1, and FIG. 6.2. Other data records may be generated and stored from the seismic data.

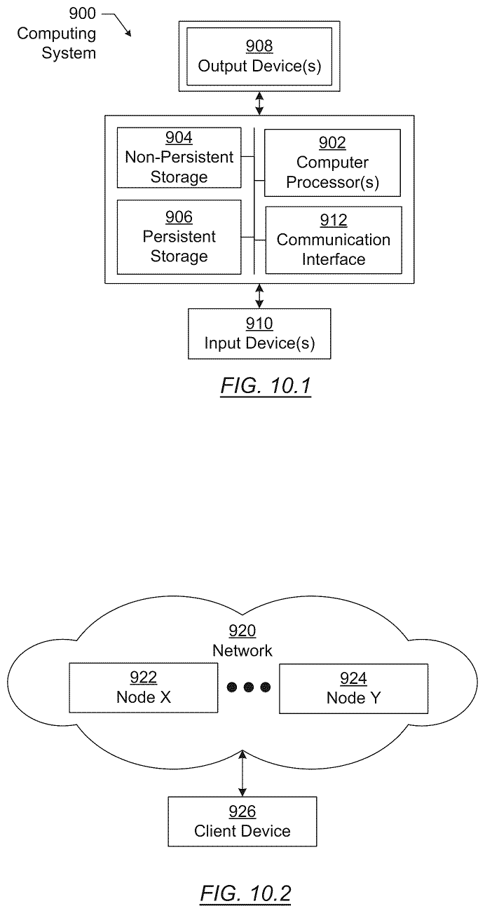

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 10.1, the computing system (1000) may include one or more computer processors (1002), non-persistent storage (1004), persistent storage (1006), a communication interface (1008) (e.g., Bluetooth interface, infrared interface, network interface, optical interface, etc.), and numerous other elements and functionalities that implement the features and elements of the disclosure. The computer processor(s) (1002) may be an integrated circuit for processing instructions. The computer processor(s) may be one or more cores or micro-cores of a processor. The computer processor(s) (1002) includes one or more processors. The one or more processors may include a central processing unit (CPU), a graphics processing unit (GPU), a tensor processing unit (TPU), combinations thereof, etc.

The input devices (1010) may include a touchscreen, keyboard, mouse, microphone, touchpad, electronic pen, or any other type of input device. The input devices (1010) may receive inputs from a user that are responsive to data and messages presented by the output devices (1012). The inputs may include text input, audio input, video input, etc., which may be processed and transmitted by the computing system (1000) in accordance with the disclosure. The communication interface (1008) may include an integrated circuit for connecting the computing system (1000) to a network (not shown) (e.g., a local area network (LAN), a wide area network (WAN) such as the Internet, mobile network, or any other type of network) and/or to another device, such as another computing device.

Further, the output devices (1012) may include a display device, a printer, external storage, or any other output device. One or more of the output devices may be the same or different from the input device(s). The input and output device(s) may be locally or remotely connected to the computer processor(s) (1002). Many different types of computing systems exist, and the aforementioned input and output device(s) may take other forms. The output devices (1012) may display data and messages that are transmitted and received by the computing system (1000). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. The software instructions may be part of a computer program product. Further, the software instructions may correspond to computer readable program code that, when executed by a processor(s), is configured to perform one or more embodiments, which may include transmitting, receiving, presenting, and displaying data and messages described in the other figures of the disclosure.

The computing system (1000) in FIG. 10.1 may be connected to or be a part of a network. For example, as shown in FIG. 10.2, the network (1020) may include multiple nodes (e.g., node X (1022), node Y (1024)). Each node may correspond to a computing system, such as the computing system shown in FIG. 10.1, or a group of nodes combined may correspond to the computing system shown in FIG. 10.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1000) may be located at a remote location and connected to the other elements over a network.

The nodes (e.g., node X (1022), node Y (1024)) in the network (1020) may be configured to provide services for a client device (1026), including receiving requests and transmitting responses to the client device (1026). For example, the nodes may be part of a cloud computing system. The client device (1026) may be a computing system, such as the computing system shown in FIG. 10.1. Further, the client device (1026) may include and/or perform all or a portion of one or more embodiments.

The computing system of FIG. 10.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures.

Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a digital seismic file;
performing autodetection of a plurality of parameters of the digital seismic file;
extracting seismic data from the digital seismic file according to the plurality of parameters of the digital seismic file to generate normalized seismic data;
scanning the normalized seismic data to obtain metadata that comprises a plurality of geographic file boundaries;
mapping the normalized seismic data to a parent virtual survey based at least in part on the plurality of geographic file boundaries being in a geographic region of a parent virtual survey; and
storing, in a target store, the normalized seismic data and metadata, the normalized seismic data in a stored relationship with the parent virtual survey in the target store.

2. The method of claim 1, further comprising:
receiving a query to the target store;
identifying the parent virtual survey responsive to the query; and
presenting the normalized seismic data responsive to the query and the stored relationship with the parent virtual survey.

3. The method of claim 1, further comprising:
for each seismic trace of a plurality of seismic traces in the normalized seismic data:
extracting a geographic boundary of the seismic trace to obtain an extracted boundary, and
updating the plurality of geographic file boundaries to encompass the extracted boundary.

4. The method of claim 1, further comprising:
comparing a plurality of polygons of a plurality of virtual surveys to a polygon defined by the geographic file boundary to obtain a comparison result,
selecting the parent virtual survey from the plurality of virtual surveys based on the comparison result.

5. The method of claim 1, further comprising:
reading an EBCDIC header from the digital seismic file to obtain an extracted header;
determining whether a keyword in a template matches the extracted header to obtain a determination result; and
selecting the template based on the determination result.

6. The method of claim 1, further comprising:
generating a normalized seismic file comprising the normalized seismic data, wherein storing the normalized seismic data comprises storing the normalized seismic file in the target store.

7. The method of claim 1, wherein the metadata comprises at least one selected from a group consisting of a plurality of corner points of seismic data, an inline boundary, a crossline boundary, and a sampling rate.

8. The method of claim 1, further comprising:
validating that the normalized seismic data is not a duplicate of seismic data stored in the target store.

9. The method of claim 1, further comprising:
comparing a checksum of a normalized seismic file comprising the normalized seismic data with a plurality of checksums in the target store to determine whether the normalized seismic data is already stored in the target store.

10. The method of claim 1, wherein performing autodetection comprises a computer processor repetitively at least until a candidate template successfully extracts the plurality of parameters:
selecting a target candidate template,
attempting extraction of a binary header using the target candidate template,
attempting extraction of a trace header using the target candidate template,
attempting extraction of the plurality of parameters when the target candidate template extracts the binary header and the trace header, and
moving to a next target candidate template when extraction of the plurality of headers is unsuccessful.

11. The method of claim 7, wherein attempting extraction of the plurality of parameters comprises:
detecting whether shot point (SP) value, common depth point (CDP) value, inline value, and crossline value in the digital seismic file are constant values,
detecting whether a source X value and a source Y value in the digital seismic file are both constant values, and
determining that the target candidate template is unsuccessful if at least one selected from the group consisting of the SP value, CDP value, inline value, and crossline value are constant values and the source X value and the source Y value are both constant values.

12. The method of claim 7, wherein attempting extraction of the plurality of parameters comprises:
detecting that a plurality of inline values forms a step increase or step decrease,
detecting that a plurality of crossline values increases or decreases for each inline value of the plurality of inline values, and
detecting that seismic data in the digital seismic file is post stacked when a crossline value of the plurality of crossline values is not repeated.

13. The method of claim 7, wherein attempting extraction of the plurality of parameters comprises:
detecting that a plurality of inline values forms a step increase or step decrease,
detecting that a plurality of crossline values increases or decreases for each inline value of the plurality of inline values, and
detecting that seismic data in the digital seismic file is pre-stacked or post stacked based on when a crossline value of the plurality of crossline values is repeated.

14. A system comprising:
memory; and
at least one processor for executing computer readable program code stored in memory and configured to:
obtain a digital seismic file;
perform autodetection of a plurality of parameters of the digital seismic file;
extract seismic data from the digital seismic file according to the plurality of parameters of the digital seismic file to generate normalized seismic data;
scan the normalized seismic data to obtain metadata that comprises a plurality of geographic file boundaries;
map the normalized seismic data to a parent virtual survey based at least in part on the plurality of geographic file boundaries being in a geographic region of a parent virtual survey; and
store, in a target store, the normalized seismic data and metadata, the normalized seismic data in a stored relationship with the parent virtual survey in the target store.

15. A computer program product comprising computer readable program code for causing a computer system to:
obtain a digital seismic file;
perform autodetection of a plurality of parameters of the digital seismic file;
extract seismic data from the digital seismic file according to the plurality of parameters of the digital seismic file to generate normalized seismic data;
scan the normalized seismic data to obtain metadata that comprises a plurality of geographic file boundaries;
map the normalized seismic data to a parent virtual survey based at least in part on the plurality of geographic file boundaries being in a geographic region of a parent virtual survey; and
store, in a target store, the normalized seismic data and metadata, the normalized seismic data in a stored relationship with the parent virtual survey in the target store.
